(19) United States
(12) Patent Application Publication
(10) Pub. No.: US 2008/0294510 A1
(43) Pub. Date: Nov. 27, 2008

(54) DETERMINING ADVERTISING EFFECTIVENESS

(76) Inventor: Frank Robert Gussoni, Trooper, PA (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 11/751,682

(22) Filed: May 22, 2007

(51) Int. Cl. G06Q 30/00; G06F 17/40

(52) U.S. Cl. 705/14; 707/104.1

(57) ABSTRACT

The effectiveness of an advertisement may be determined. The advertisement and an incentive may be received at a data server. An online request from a consumer for a product may be received. The product may correspond to the incentive. The advertisement may be presented to a consumer. The advertisement may be presented in connection with the incentive and a first identifier. The first identifier may be generated unique to the presentation of the advertisement. The first identifier may include a bar code. When the incentive is redeemed, data indicative of the incentive being redeemed may be correlated to the first identifier. The incentive may be redeemed at a physical store, at an online store, and the like. First data indicative of the incentive being redeemed may be received. The first data may be correlated with the first identifier. The advertisement may be correlated to the redemption of the incentive.

### BACKGROUND

Advertisers face difficulty, expense, and uncertainty attempting to estimate the effectiveness of advertising. While advertisers may rely on focus groups and surveys to gauge the extent that particular advertisements reach consumers, such methods do not address how effective those advertisements are at converting potential customers into paying customers.

In addition, communications media reaching prospective consumers have been growing increasingly distributed. Numerous emerging media such as internet advertising, on-demand and digital video recorder screens, e-mail newsletters, software embedded advertisements, video and audio podcasts, and the like have been supplanting traditional media outlets such as radio, television, and print media, for advertising.

This increasing number of media channels presents greater opportunity to address potential customers; however, the wider range of options poses a problem for advertisers seeking to maximize the effectiveness of their limited budgets. Because advertisers have more choices in media, being able to determine the effectiveness of advertisements when selecting media takes on a growing importance.

On the other hand, advertisers are not alone in being influenced by this trend of more pervasive media. Consumers, too, feel the impact of increased advertising. By being bombarded with new media advertisements, in addition to the traditional media channels, consumers are increasingly more selective about which advertisements and messages they should devote their attention.

Addressing this, permission-based advertising allows the consumer to select the quantity and the nature of the commercial messages that interests them. Permission-based advertising allows a consumer to directly or indirectly indicate areas of interest. In response, specific, targeted advertisements can be presented that meet the individual consumer's need.

Thus, there is a need for an accurate method of determining advertising effectiveness that can directly identify the revenue attributable to the particular advertisement while leveraging a permission-based approach.

### SUMMARY

A method and system for determining the effectiveness of an advertisement is disclosed. The advertisement and/or an incentive may be received at a data server. The incentive may correspond to a product, and the incentive may include a percentage discount, a reduction in price, and the like.

An online request to the data server from a consumer for the product may be received. The online request may include selecting a product by supplier, selecting a product by product type, receiving search terms from the consumer, and the like. The advertisement may be presented to a consumer. The advertisement may be presented in connection with the incentive and/or a first identifier. The first identifier may be generated unique to the presentation of the advertisement. The advertisement may include a video associated with the product.

The incentive may be presented in a printable form. For example, the first identifier may include a bar code. When the incentive is redeemed, data indicative of the incentive being redeemed may be correlated to the first identifier. The incentive may be redeemed at a physical store, at an online store, and the like.

First data indicative of the incentive being redeemed may be received. The first data may be correlated with the first identifier. The advertisement may be correlated to the redemption of the incentive.

A system for determining the effectiveness of an advertisement may include a datastore and a processor. The datastore may store an advertisement and an incentive. The processor may present the advertisement in connection with the incentive and generate a first identifier unique to the presenting. The incentive may be such that when redeemed data indicative of the incentive being redeemed correlates to the first identifier.

### BRIEF DESCRIPTION OF THE DRAWINGS

FIG. 1a depicts an exemplary system for tracking the effectiveness of an advertisement;

FIG. 1b depicts an exemplary data server;

FIG. 1c depicts an exemplary advertisement;

FIG. 2 is a process flow diagram illustrating an exemplary method for tracking the effectiveness of an advertisement; and

FIGS. 3a-3d depict exemplary web pages for interacting with a consumer.

### DETAILED DESCRIPTION

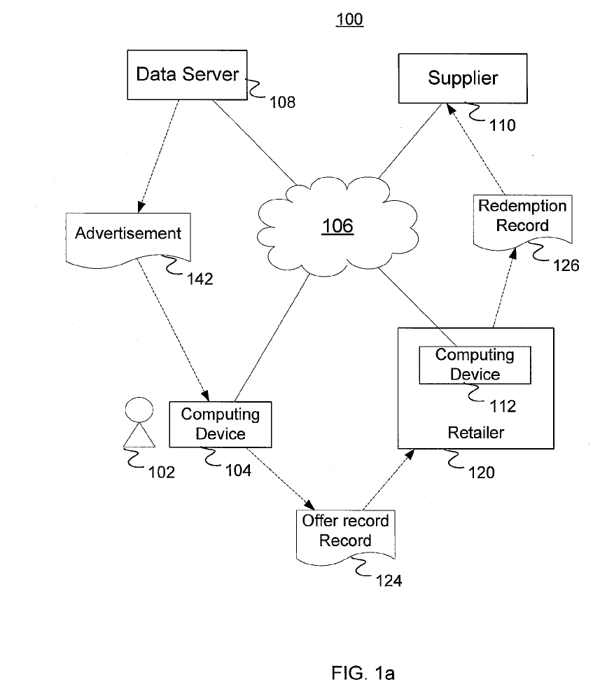

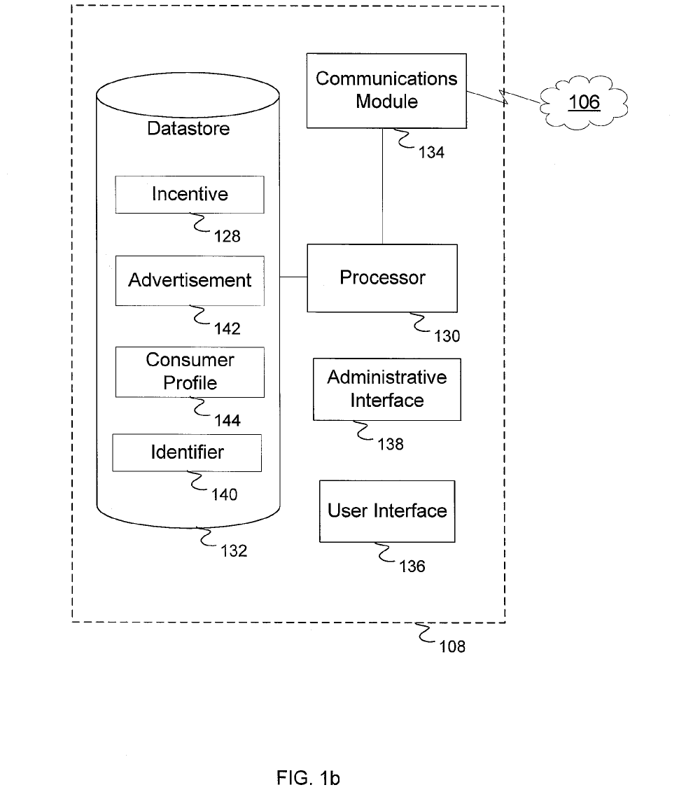

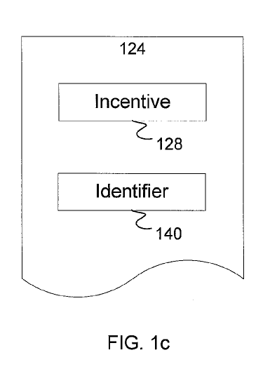

FIG. 1a depicts an exemplary system 100 for tracking the effectiveness of an advertisement 142. The system 100 may include a network 106 that connects a data server 108, a consumer's computing device 104, a retail location's computing device 112, and/or a supplier 110. The network 106 may be any system suitable for communicating data. For example, the network 106 may be the Internet. In one embodiment, the network 106 may be an intranet, extranet, local area network (LAN), wide area network (WAN), a public switched telephone network (PTSN), Global System for Mobile Communication (GSM), wireless LAN, Institute of Electrical and Electronics Engineers (IEEE) 802.11x, and the like.

The consumer's computing device 104 may be a personal computer (PC), laptop computer, handheld device such as a personal digital assistant (PDA), cellular phone, and the like. The computing device 104 may be any device suitable for connecting to the network 106 and/or engaging the consumer 102 and/or the data server 108.

In one embodiment, the consumer 102 may engage the data server 108 via a telephone. The consumer 102 may set up a voice connection with an interactive voice response (IVR) unit in operative communication with the data server 108. The consumer 102 and/or data server 108 may communicate using text-to-speech, recorded voice prompts, speech recognition, dual-tone multi-frequency (DTMF) detection, and similar technologies.

In one embodiment, the consumer 102 may use the computing device 104 to communicate with the data server 108. For example, the consumer's computing device 104 may be loaded with software suitable for communicating with the data server 108. For example, the software may be an Internet browser, Really Simple Syndication (RSS) feed reader, usenet newsreader, e-mail client, and/or other software that provides interaction between the consumer 102 and/or the data server 108. The consumer 102 may request and/or view a website presented by the data server 108. The data server 108 may include a web server for communicating with the consumer's computer 104 via hypertext transfer protocol (HTTP).

The consumer 102 may engage the data server 108 to research a product. Referring to FIG. 1b that depicts an exemplary data server 108. The data server 108 may include a processor 130 in operative communication with a datastore 132 and/or a communications module 134. The data server 108 may enable a consumer interface 136 and/or an administrative interface 138. The datastore 132 may store data an incentive 128, an advertisement 142, an identifier 140, and/or a consumer profile 144.

The product may be in the form of a good, a service, or a combination of the two. The product may be a tangible and/or intangible item. For example, the product may be an entitlement and/or other rights that may be purchased and/or sold.

In one embodiment, responsive to the consumer 102, the data server 108 may present an advertisement 142. The advertisement 142 may be any communication related to the product. For example, the advertisement 142 may be a description of the product, an image of the product, a video of the product, and/or audio associated with the product.

In another embodiment, the advertisement 142 may be a billboard, television broadcast, radio broadcast, on-line graphic and/or banner, printed publication, and the like. For example, where the consumer 102 is within proximity of the billboard advertisement 122, the data server 108 and/or the consumer 102 may interact via a cellular telephone.

In one embodiment, the incentive 128 may be any benefit that may tend to motivate the consumer 102 to purchase the product. For example, the incentive 128 may include a percentage reduction in the purchase price of the product. Also for example, the incentive 128 may include a fixed reduction in the purchase price of the product. In another embodiment, the incentive 128 may include a free gift and/or other compensation for purchasing the product. For example, the incentive 128 may grant the consumer 102 a reduction in the overall price when a collection of items are purchased such that the product is included in the collection of items. In another embodiment, the incentive 128 may take the form of an exclusive offer and/or exclusive product. In an embodiment, the incentive 128 may include special financing. For example, the incentive 128 may provide a loan with a lower interest rate and/or enhanced loan terms.

The communications module 134 may enable communication between the processor 130 and/or the network 106. The administrative interface 138 may provide an interface for provisioning, support, maintenance and the like. For example, the advertisement 142 and/or the incentive 128 may be received from a supplier 110 and/or retailer 120 through the administrative interface 138. The administrative interface 138 may support HTTP, extensible markup language XML, and the like. The consumer interface 136 may be a website or other interface that may be presented to the consumer 102. When the consumer 102 engages the data server 108, the processor 130 may pull data from the datastore 132 to format according to the consumer interface 136 and present as a webpage to the consumer 102.

Upon engaging the data server 108, the consumer 102 may be presented with a welcome message. For example, the welcome message may include text, graphics, animation, and the like. The consumer 102 may be presented with the ability to browse categories and/or subcategories of products. For example, the consumer 102 may be able to browse by product type, supplier, and other such product descriptors. Also for example, the consumer 102 may search for a product. The data server 108 may respond to search terms entered by the consumer 102, and the data server 108 may display of a list of products related to the search terms.

Information related to the products displayed by the data server 108 may be stored in the datastore 132. This data may have been provided by the supplier 110, retailer 120, and/or third-party, for example. The product information may include the product's model number, the supplier's name, the supplier's logo, a description of the product, an image of a product, the stock keeping unit (SKU) associated with the product, an audio/video presentation associated with the product, and the like. For example, the information may include an embedded product video that includes testimonials, demonstrations of the product, advertising messages related to the product, commercials, consumer-created content, and the like. Each product may include more than one product video, and each product video may be selected and played by the consumer 102.

Within a session with the data server 108, the consumer 102 may browse multiple products. While the consumer 102 navigates the website, viewing product information and/or product videos, the data server 108 may track the consumer's progress. For example, the server may maintain a log that records the consumer's interaction with the data server 108. In one embodiment, the log may record the consumer's click-path and/or the duration for which each web page is displayed.

Each consumer 102 may be associated with a consumer profile 144. The consumer profile 144 may include the consumer's name, address, e-mail address, and/or other such biographical information. The consumer profile 144 may also include consumer preferences as directly or indirectly indicated by the consumer 102. For example, the consumer's click path and/or page durations may indirectly indicate the consumer's preferences in products.

Also within the session with the data server 108, the consumer 102 may be presented with an offer record 124 in connection with the advertisement 142. Referring to FIG. 1c that depicts an exemplary offer record 124, the advertisement 142 may be associated with one or more offer records 124. The offer record 124 may include the incentive 128 related to the product. The incentive 128 may be retrieved from the datastore 132. Where the incentive 128 is static, it may be displayed directly to the consumer 102. Where the incentive 128 is dynamic, it may be calculated based the associated rule set. In one embodiment, the rule set may consider the consumer's profile 144 in determining the incentive 128. The dynamic incentive 128 may be based on the consumer's history, click-path and/or browsing patterns, the consumer's location, and/or any other information available to the system. For example, where a consumer's history indicates that the consumer 102 browses across many different products, the incentive 128 for a given product may be greater than that if the consumer 102 viewed only one product. The offer record 124 may also contain the product name, the supplier's name, the product's SKU, the terms and conditions related to the incentive 128, the consumer's name, and/or an identifier 140.

The offer record 124 may include an identifier 140. The identifier 140 may generated by the processor 130 in connection with the presentation of the advertisement 142. The identifier 140 may be unique to the presentation of the advertisement 142. The identifier 140 may link the presentation of the advertisement 142 to the incentive 128. In one embodiment, the identifier 140 may indicate the consumer 102 and/or the specific session during which the advertisement 142 was displayed to the consumer 102. For example, the identifier 140 may be linked and/or keyed to the consumer's interaction with the data server 108. Also for example, the identifier 140 may be linked to the consumer profile 144. In one embodiment, the identifier 140 may relate to the specific instance of the advertisement 142 as presented independent of the consumer 102. For example, where the advertisement 142 is presented once and viewed by more than one consumer 102, the identifier 140 may be logically related to the advertisement 142 independent of the consumer 102. In another embodiment, the identifier 140 may be logically related to both the presentation of the advertisement 142 and/or the specific consumer 102 to whom the advertisement 142 was presented. The incentive 126 may be provided by the supplier of the product, and/or it may be provided by the retailer of the product. More than one incentive 126 may be provided. For example, a first incentive 126 may be provided by a supplier of the product, and a second incentive 126 may be provided by a retailer of the product.

The offer record 124 may be in any format that may be presented to at a retailer 120 for redemption. For example, a offer record 124 may be displayed as a webpage that the consumer 102 may print using a printer connected to the consumer's computing device 104. In one embodiment, the offer record 124 may include a bar code for encoding data. The bar code may be formatted as a universal product code (UPC). The bar code may include a coupon code within the UPC format.

In one embodiment, the offer record 124 may be displayed on a handheld device such as a PDA and/or cell phone. For example, the offer record 124 may be sent to the consumer's handheld device. The bar code may be displayed on the screen of the handheld device such that it may be redeemed at a retailer 120 when purchasing the product. The retail location 120 may include a computing device 112 for scanning and/or recording the offer record 124 for redemption.

In one embodiment, the offer record 124 may be virtual. For example, the offer record 124 may include data sent to the retail location 120, such that when the consumer 102 presents identification at the time of purchase, the consumer 102 may be correlated with the offer record 124. In another embodiment, the offer record 124 may be associated with the consumer's credit card. For example, the offer record 124 may be automatically redeemed when the consumer 102 purchases the product with the credit card.

In one embodiment, the offer record 124 may be mailed and/or shipped to the consumer 102. In another embodiment, the consumer 102 may have a plastic card and/or other consumer ID associated with the incentive system 100. For example, the consumer ID may be linked to the consumer's profile 144 and/or further linked to the offer record 124, such that when the plastic card and/or other consumer ID is presented at the retailer 120 with purchase of the product, the incentive 128 may be credited to the consumer 102.

The identifier 140 that is included in the offer record 124 may be stored in the datastore 132. The datastore 132 may maintain the identifiers 140 each associated with specific presentations of the advertisement 142. The datastore 132 may maintain data associated with each identifier 140. For example, the datastore 132 may include the date and/or time of the presentation of the advertisement 142, the identity of the consumer, the duration of time associated with the presentation of the advertisement 142, related click history and/or consumer interaction, and the like. The identifier 140 and/or related incentive 128 may be stored retrievably such that when the incentive 128 is redeemed, the redemption may be correlated with the presentation of the advertisement 142.

The consumer 102 may purchase the product at the retailer 120. In one embodiment, the retailer 120 may be any individual and/or entity that sells and/or deals in the product. The retailer 120 may be a physical location and/or store at which the product may be purchased. The retailer 120 may include an on-line store at which the product may be purchased. The on-line store may include an electronic commerce modality for purchasing the product. For example, the retailer 120 may be a store, outlet center, mall, and the like. At the retailer 120, the consumer 102 may present the offer record 124 to redeem the incentive 128. The retailer 120 may include a computing device 112 suitable for processing the offer record 124 and/or crediting the consumer 102 the incentive 128. For example, the computing device 112 may include a barcode scanner in operative communication with a processor. The barcode scanner may decode the bar code associated with the offer record 124.

In one embodiment, the computing device 112 may communicate the purchase of the product and/or the redemption of the incentive 128 to the supplier 110 directly via the network 106. In another embodiment, the computing device 112 may communicate the purchase of the product and/or the redemption of the incentive 128 to the supplier 110 indirectly via network 106 and/or the data server 108. This reporting may be with a redemption record 126. The redemption record 126 may include the identifier 140 of the offer record 124. The redemption record 126 may include information that is logically connected to the identifier 140. The supplier 110 may receive from the data server 108 data indicative of the products, description views, video views, and/or offer records 124 issued that are associated with the supplier 110.

In one embodiment, the redemption record 126 may include a copy of the offer record 124. Upon redeeming the incentive 128, the consumer 102 may physically hand over the offer record 124 to the retailer 120. The retailer 120 may then mail a copy of the offer record 124 to the supplier 110. The retailer 120 may be reimbursed by the supplier 110 for the value of the incentive 128. Where the retailer 120 issued the incentive 128, the retailer 120 may retain the offer record 124 as the redemption record 126.

The redemption record 126 may be correlated with specific presentation of the advertisement 142. For example, the supplier 110 and/or the retailer 120 may receive a report that includes the number of times a product video has been viewed and/or the number of offer records 124 that have been issued. Based on the identifier 140, the specific session of the consumer 102 that generated the offer record 124 may be correlated to the purchase of the product. As aggregated across many consumers, this data may provide an indication of the effectiveness of the product description, product video, and/or incentive 128, for example. Data associated with the redemption record 126 may include the location purchase, the time and/or date of the purchase, an aggregate cost of the order, and/or a list items purchased.

Since the advertisement 142 may be correlated with a purchase via the redemption record 126, the effectiveness of the advertisement 142 may be assessed. The advertisement 142 may be presented to a number of different customers, each with a different identifier 140. Since only some of the incentives may be redeemed, comparing the number of redemption records 126 to the number of generated identifiers 140 may be indicative of the effectiveness of the advertisement 142.

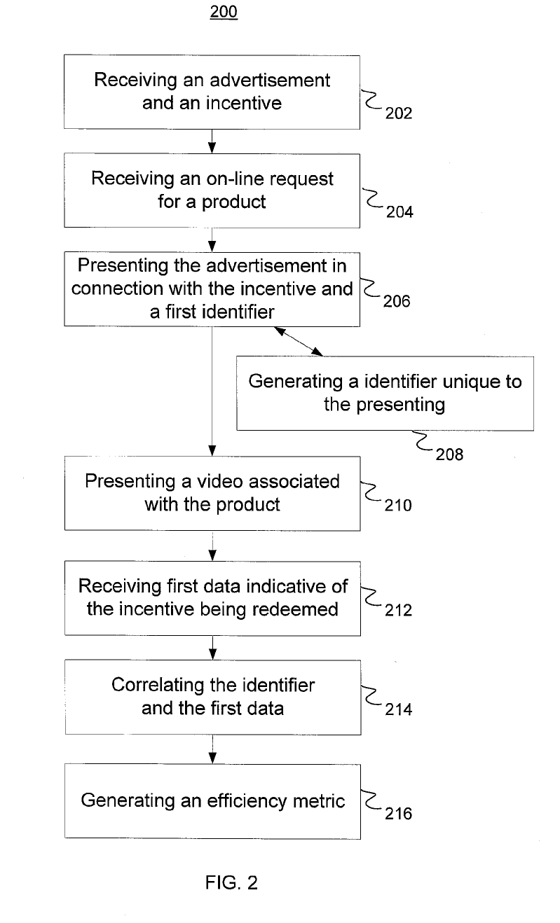

FIG. 2 is a process flow diagram illustrating an exemplary method for tracking the effectiveness of an advertisement 142. At 202, an advertisement 142 and/or an incentive 128 may be received. In one embodiment, this information may be sent directly to the data server 108 electronically, or it may be communicated to an administrator who enters the data into the data server 108 via the administrative interface 138. In one embodiment, data indicative of a product may be received. Data indicative of the product may include product name, product SKU, and/or the name of supplier, for example. The data indicative of a product also may include product information, a description of the product, an image and/or picture of the product, and/or one or more videos depicting the product or describing it, for example.

At 204, the data server 108 may receive an online request for a product from the consumer 102. The online request may be received in the form of an HTTP request at a website. In one embodiment, the online request may include a selection by the consumer of a product that is sorted by supplier. In one embodiment the online request may take the form of the consumer selecting a product sorted by the type of product. In another embodiment, the online request may include a search term entered by the consumer 102. The search term may include the product's name, the supplier's name, terms related to the nature and/or function of the product, and the like.

At 206, the advertisement 142 may be presented in connection with the incentive 128. The advertisement 142 may include a product description, an image, a video, and/or the like. In one embodiment, the advertisement 142 may be presented without an initial interaction between the consumer 102 and/or the data server 108. For example, the advertisement 142 may include a printed publication with a code. The consumer 102 may use the code in a later interaction with the data server 108.

At 208, an identifier 140 may be generated. The identifier 140 may be generated in conjunction with the presentation of the advertisement 142. The identifier 140 may be generated to be unique to the specific presentation of the advertisement 142. The identifier 140 may be large serial number. For example, the identifier 140 may be a 128-bit number. For example, the identifier 140 may be generated by incrementing a serial number for each presentation. The identifier 140 may link the specific instance of the advertisement 142 to the incentive 128. For example, the identifier 140 may link the consumer's perception of the advertisement 142 to the incentive 128. Thus, when the incentive 128 is redeemed by the consumer, the identifier 140 may be correlated back to the specific presentation of the advertisement 142.

In one embodiment, the incentive 128 may be displayed on a computer screen, the display of a handheld device and/or cell phone, and the like. The incentive 128 may be presented to the consumer 102 via a webpage, such that the consumer 102 may print out the incentive 128. The data presented to the consumer 102 may include the supplier's name, the product name, the product SKU, the terms and conditions of use associated with the incentive 128, details associated with the incentive 128, the consumer's name, and/or the identifier 140 that relates to this presentation. The incentive 128 and/or the identifier 140 may be presented in the offer record 124.

At 210, the advertisement 142 may include a video associated with the product. For example, the consumer 102 may continue to browse product information such as a video depicting and/or describing the product. The data indicative of the product may be presented to the consumer all at once or in stages. For example the consumer 102 may be first presented with the name and/or image of the product, and upon receiving another online request for the product, the consumer 102 may be presented with a description. The description may include a number of hyperlinks to product videos.

The consumer may redeem the incentive 128 at a retailer 120 by presenting the offer record 124. The retailer 120 may credit the incentive 128 with purchase of the product. The incentive 128 may be redeemed at an on-line store and/or at a physical store. For example, the consumer 102 may physically purchase the product at a store. At the point-of-sale, the consumer 102 may present the incentive 128 to the retailer 120. The incentive 128 may be encoded as a barcode coupon, for example. The retailer 120 may credit the incentive 128 upon purchase the product and/or at a later time. The retailer 120 may consider the terms and conditions of use associated with the incentive 128 when crediting the incentive 128.

At 212, data indicative of the incentive 128 being redeemed may be received. In one embodiment, the first data may be a copy of the identifier 140, sent from the retailer 120 to the data server 108. In another embodiment, the first data may be sent to the supplier. The data indicative of the incentive 128 being redeemed may be a redemption record 126. The data indicative of the incentive 128 being redeemed may include a date, time, location, and the like.

At 214, the first data may be correlated with the identifier 140. In one embodiment, the first data may include a copy of the identifier 140 which may be matched to the identifier 140 stored by the datastore 132. In one embodiment, the advertisement 142 may be correlated to the redemption of the incentive 128. The correlations may be aggregated to present an overall picture of the effectiveness of the advertisement 142 across multiple consumers.

At 216, an efficiency metric may be generated from the correlated identifier and/or the first data. The efficiency metric may compare number of distinct identifiers 140 that have been generated in connection with a particular advertisement 142 to the number of associate redemption records 126 that have been received. In one embodiment, the efficiency metric may relate to the time and/or place the advertisement 142 was presented, the channel in which the advertisement 142 was presented, the nature of the incentive 128, and the like.

All and/or part of the process described in FIG. 2 may be encoded in computer executable instructions via a computer programming language. The computer executable instructions may be stored on a computer readable medium, for example a hard drive, CD-ROM, DVD-ROM, and the like.

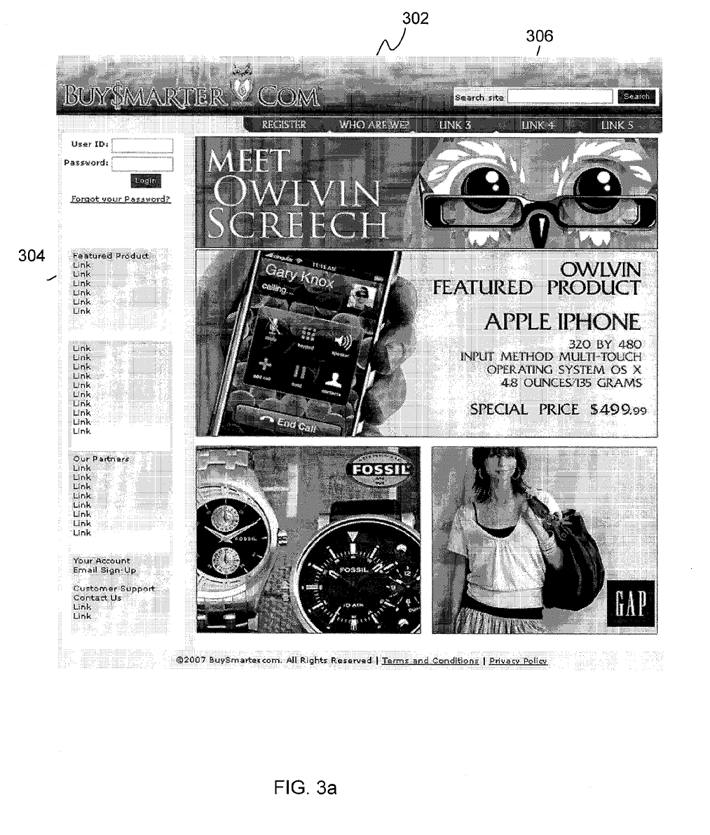

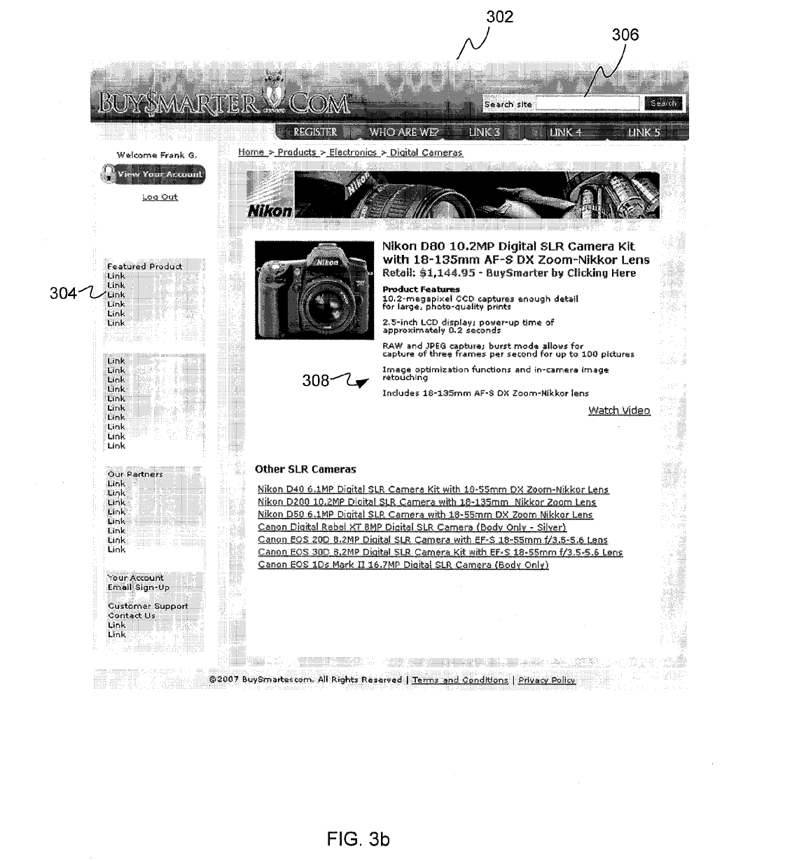

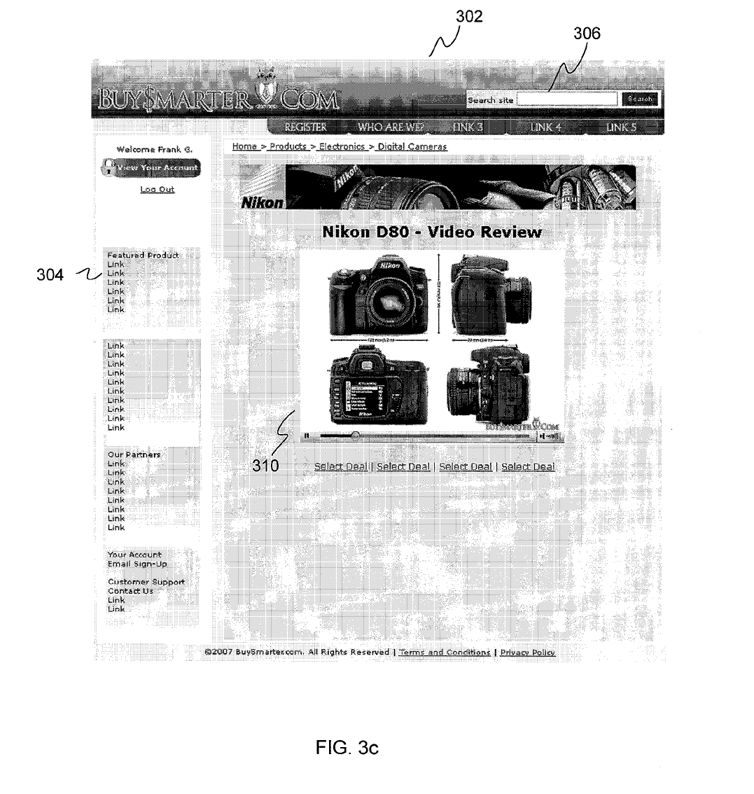

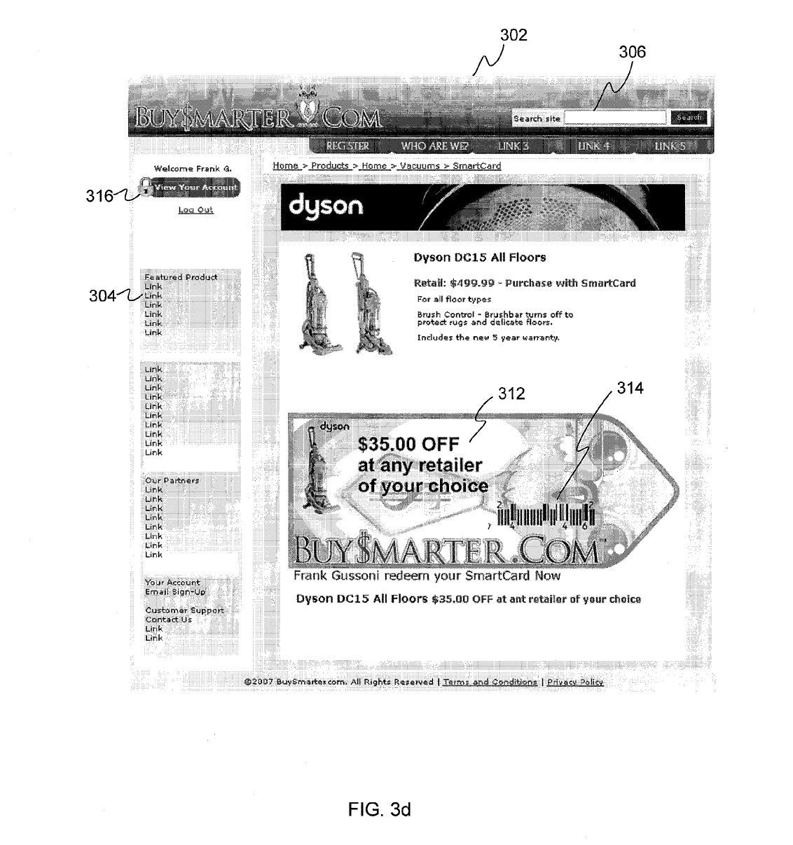

FIGS. 3a-3d depict an exemplary website 302 for interacting with a consumer 102. The website 302 may receive an online request from the consumer 102. For example, the website 302 may include links 304. Each link 304 may be associated with a product. The links 304 may be organized by supplier, product type, and the like. Also for example, the website 302 may include a search box 308 that may receive search terms from the consumer 102. Responsive to the consumer's search terms, the website 302 may display products associated with the search terms.

Once the consumer 102 has selected a product, the website 302 may display a description 308 of the product. For example, the website 302 may display an image of the product, technical and/or descriptive information about the product, the product's typical cost, and the like. In addition, the website 302 may present a video 310 to the customer 102. The video 310 may be associated with the selected product.

The website 302 may present the consumer 102 with data 312 indicative of an incentive 128. For example, the data 312 may be presented as part of a printable webpage. The data 312 may relate to the consumer's online request by an identification code 314. For example, the identification code 314 may be encoded as a bar code. The website 302 may store a profile 316. The profile 316 may be associated with a consumer. The data 312 may be linked to the profile 316. The consumer 102 may purchase the product at a location and/or redeem the incentive 128.

As a useful and tangible result, the redemption record 126 may be correlated to the identifier 140. From this correlation, the supplier 110 may determine that the specific presentation of the advertisement 142 resulted in a purchase. A tangible efficiency metric may result. This data may be aggregated across many consumers and many advertisements, including advertisements in different channels, such as different websites. From the aggregation of correlation data, the supplier may determine which channels and which advertisements best result in purchases.

What is claimed:

1. A method of determining the effectiveness of an advertisement, the method comprising:
presenting the advertisement in connection with the incentive, the incentive comprising a first identifier of the presenting;
receiving first data indicative of the incentive being redeemed; and
correlating the first identifier and the first data.

2. The method of claim 1, wherein correlating the first identifier and the first data comprises correlating the advertisement and a redemption of the incentive.

3. The method of claim 1, wherein the incentive comprises a percentage discount.

4. The method of claim 1, wherein the incentive comprises a reduction in price.

5. The method of claim 1, wherein the incentive comprises special financing.

6. The method of claim 1, wherein the incentive is provided by a supplier of the product, and wherein the second data is indicative of a second incentive that is provided by a retailer of the product.

7. The method of claim 1, wherein the incentive is redeemed at a physical store.

8. The method of claim 1, wherein the incentive is redeemed at an online store.

9. The method of claim 1, further comprising receiving an online request for a product, wherein the product corresponds to the incentive.

10. The method of claim 9, further comprising presenting a video associated with the product to the consumer.

11. The method of claim 9, wherein the receiving an online request comprises selecting a product by supplier.

12. The method of claim 9, wherein the receiving an online request comprises selecting a product by product type.

13. The method of claim 9, wherein the receiving an online request comprises receiving search terms from the consumer.

14. The method of claim 1, wherein the presenting comprises presenting in a printable form.

15. The method of claim 1, further comprising storing a profile associated with the online request.

16. The method of claim 15, wherein the incentive is linked to the profile.

17. The method of claim 1, further comprising receiving indication that the incentive was redeemed.

18. A system for determining the effectiveness of an advertisement, the system comprising:
a datastore that stores first data indicative of the incentive being redeemed; and
a processor that presents the advertisement in connection with the incentive, the incentive comprising a first identifier of the presenting and that correlates the first identifier and the first data.

19. The system of claim 18, wherein the processor receives an online request for a product, wherein the product corresponds to the incentive.

20. The system of claim 18, wherein the processor presents a video associated with the product to the consumer.

21. The system of claim 18, wherein the processor presents the first identifier in a printable form.

22. The system of claim 18, wherein the first identifier includes a bar code.

23. The system of claim 18, wherein the processor receives indication that the incentive was redeemed.

24. A computer readable storage medium for determining the effectiveness of an advertisement, the computer readable storage medium having stored thereon computer executable instructions to perform a method comprising:
presenting the advertisement in connection with the incentive, the incentive comprising a first identifier of the presenting;
receiving first data indicative of the incentive being redeemed; and
correlating the first identifier and the first data.
